(19) United States
(12) Patent Application Publication
(10) Pub. No.: US 2002/0130220 A1
(43) Pub. Date: Sep. 19, 2002

(54) Airships having simplied construction and improved maneuverability

(76) Inventors: Bob Sparks, Slatington, PA (US); Richard Schriebmaier, Sugarloaf, PA (US)

Correspondence Address: KNOBLE & YOSHIDA, EIGHT PENN CENTER, SUITE 1350, 1628 JOHN F KENNEDY BLVD, PHILADELPHIA, PA, 19103, US

(21) Appl. No.: 09/730,870

(22) Filed: Mar. 13, 2001

(51) Int. Cl. B64B 1/58

(52) U.S. Cl. 244/128

(57) ABSTRACT

An improved airship that is uniquely constructed so as to be inexpensive yet easy to pilot and highly maneuverable includes an outer skin that defines a nose portion and a tail portion of the airship and an internal envelope. At least one gas bag is contained within the envelope. A gondola is secured to and positioned beneath the outer skin. Most advantageously, a propulsion mechanism is positioned proximate to the tail portion and is constructed and arranged to create propulsive thrust that is vectored so as to be substantially colinear with a centerline of the airship that extends through the nose portion and the tail portion of the airship. The airship also may include a ballonet-free internal pressurizing system that introduces outside air into a location between the outer skin and the gas bag when pressure at that location has reached a predetermined minimum pressure. As a result, the envelope is sufficiently pressurized to maintain its outer shape without use of a ballonet. The airship may further include a system for maintaining trim that operates by transferring gas between a first gas bag that is located proximate the nose of the airship and a second gas bag that is located proximate to the tail of the airship.

### BACKGROUND OF THE INVENTION

1. Field of the Invention

This invention relates generally to the field of airships, which are defined as lighter-than-air aircraft. More specifically, this invention pertains to an airship that is designed to be simple and inexpensive to make and maintain and that is highly maneuverable.

2. Description of the Related Technology

An airship or dirigible is a lighter-than-air craft that includes a compartment or bag containing a gas that is lighter than the ambient air to lift the ship, a propulsion system, a system for adjusting buoyancy, and one or more gondolas for the crew, passengers, and power units. The lighter than air gas is most typically hot air, helium or hydrogen, and the airship is usually elongated or streamlined to enable easy passage through the air. The propulsion system usually includes one or more engines and propellers. The system for adjusting buoyancy usually includes ballast, which is most typically sand or water. Gas may also be released from the compartment or bag to reduce buoyancy. To steer the airship, the pilot typically uses one or more vertically hinged rudders. To control altitude, the pilot employs one or more horizontally hinged elevators.

The first airship was flown in France in the early 1850s by Henri Giffard, and for the following 80 years or so the airship achieved a preeminent role in early aviation. For example, airships were used for the first regularly scheduled commercial passenger aviation service, which appeared in Germany in the second decade of the 20th century. Eventually, however, the superior speed of fixed-wing aircraft prevailed and therefore the airship does not figure prominently in commercial aviation today.

Typically, an airship houses its propulsion system, engines and propellers on or close to the gondola or cabin, which is almost always on the lower end of the bag or compartment in which the gas is contained. As a result of this, when the speed of the airship is increased, the nose of the airship tends to resist penetration of the air and will have a tendency to rise. To adjust for this effect and other similar effects during operation, many modern airships include as part of their ballast system a number of small balloons or “ballonets” within the meaning, outer skin or bag that can be inflated were deflated during flight. If areas pumped into one of the forward ballonets, the weight of the air is added to the nose of the airship, and the volume of this air within the ballonet will additionally forced the lifting gas to the air of the airship. This procedure can be used to trim the airship to the desired pitch, so that the nose of the airship is kept from rising too far at higher speeds. Unfortunately, this procedure must be reversed when the speed of the aircraft is decreased. The constant need to adjust trim adds considerably to the complexity of flying a traditional airship.

Accordingly, the classic or traditional airship has an outer skin of strong fabric that must take the stress of the inner pressure as well as the ultraviolet rays of the sun and other harmful elements to which is subjected for hundreds of hours of flying. There is a second bag inside this which is built and used for its gas holding qualities. Ballonets inside are utilized for transferring air fore and aft to control trim and pressure.

Airships, because of the inherent safety that is provided by their lighter than air nature, would be an ideal platform for a small, personal light aircraft, or for hobbyists. However, the complexities described above and related, similar difficulties in piloting a traditionally designed airship have to date prevented this from happening on a widespread scale. A need exists for an improved airship design that is simple and inexpensive to make and that is less complicated to maneuver in comparison to traditional airships.

### SUMMARY OF THE INVENTION

Accordingly, it is an object of the invention to provide an improved airship design that is simple and inexpensive to make and that is less complicated to maneuver in comparison to traditional airships.

In order to achieve the above and other objects of the invention, an airship that is constructed according to a first aspect of the invention includes an outer skin having an outer surface and an inner surface, the inner surface defining an envelope; at least one gas bag contained within the envelope; a cabin; a pressure sensor positioned to sense air pressure at a location between the gas bag and the inner surface of the outer skin; and a pressurizing system for introducing outside air to the location when the pressure sensor detects that pressure at the location has reached a predetermined minimum pressure, whereby the envelope is sufficiently pressurized to maintain its outer shape without use of a ballonet.

According to a second aspect of the invention, an airship includes an outer skin having an outer surface and an inner surface, the outer surface defining a nose portion and a tail portion of the airship and the inner surface defining an envelope; at least one gas bag contained within the envelope; a cabin; and a propulsion mechanism that is positioned proximate to the tail portion, the propulsion mechanism being constructed and arranged to create propulsive thrust that is vectored so as to be substantially collinear with a centerline of the airship that extends through the nose portion and the tail portion of the airship.

These and various other advantages and features of novelty that characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a preferred embodiment of the invention.

### BRIEF DESCRIPTION OF THE DRAWINGS

FIG. 1 is a diagrammatical view depicting an airship that is constructed according to a first embodiment of the invention;

FIG. 2 is a second diagrammatical view depicting an airship that is constructed according to a second embodiment of the invention;

FIG. 3 is a third diagrammatical view depicting a feature of the invention that is preferably included in both the first and second embodiments of the invention;

FIG. 4 is a fourth diagrammatical view depicting operation of the feature of the invention that is shown in FIG. 3;

FIG. 5 is a fifth diagrammatical view depicting an alternative embodiment of another aspect of the invention; and

FIG. 6 is a schematic diagrammed depicting a control system for an airship constructed according to the invention.

### DETAILED DESCRIPTION OF THE PREFERRED EMBODIMENT(S)

Referring now to the drawings, wherein like reference numerals designate corresponding structure throughout the views, and referring in particular to FIG. 1, and airship 10 constructed according to a preferred embodiment of the invention includes an outer skin 12 having an outer surface 14 that defines the outer shape of the airship 10 and an inner surface 16 that defines an envelope 18 in which at least one gas bag 20 is located. A cabin that is in the preferred embodiment a gondola 22 that is attached to and positioned beneath the outer skin 12, and preferably contains at least a cockpit area for seating the pilot of the airship 10. Alternatively, a cabin could be provided within the envelope defined by the outer skin 12. A number of pilot interface controls that will be discussed in greater detail below will be located within this cockpit area. In addition, the gondola 22 will preferably contain the power source or sources for providing power to the propulsion mechanism for the airship 10, although preferably not the propulsion mechanism itself, for reasons that will be explained in greater detail below.

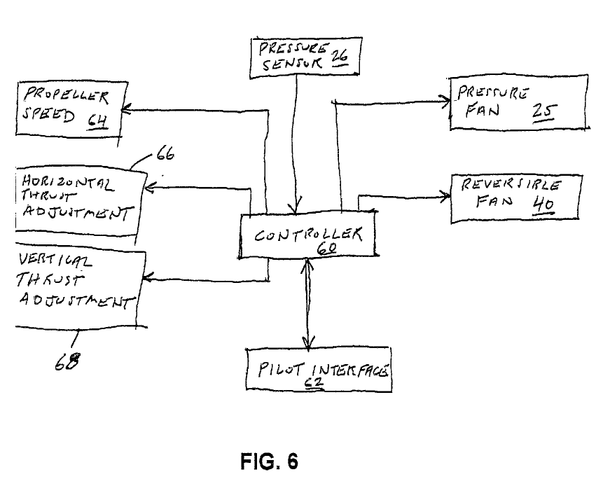

Referring again to FIG. 1, it will be seen that in this embodiment there is but one gas bag 20, and a space 24 is defined between a bottom area of the gas bag 20 and the inner surface 16 of the outer skin 12 at the bottom of the airship 10. According to one advantageous aspect of the invention, a system is provided for maintaining adequate pressurization within the envelope 18 so that the airship 10 retains its shape, and the system is unique in that it does not rely upon any ballonets. Instead, a pressure sensor 26 is provided for sensing the air pressure within the space 24 and a pressure fan 25 is provided for forcing outside air into the space 24 when power is supplied to the pressure fan 25. Referring briefly to FIG. 6, a controller 60 receives input from the pressure sensor 26 and instructs the pressure fan 25 to operate when the air pressure within the space 24 falls beneath a predetermined minimum value. The air that is blown into the space 24 by the pressure fan 25 will stay at the bottom of the gas bag 20 and envelope 18, thereby in effect forming a natural ballonet. This makes it easy to keep the necessary pressure at a constant and little energy is required. The pressure fan 25 will not run continually, but shape is maintained and pressure is constant.

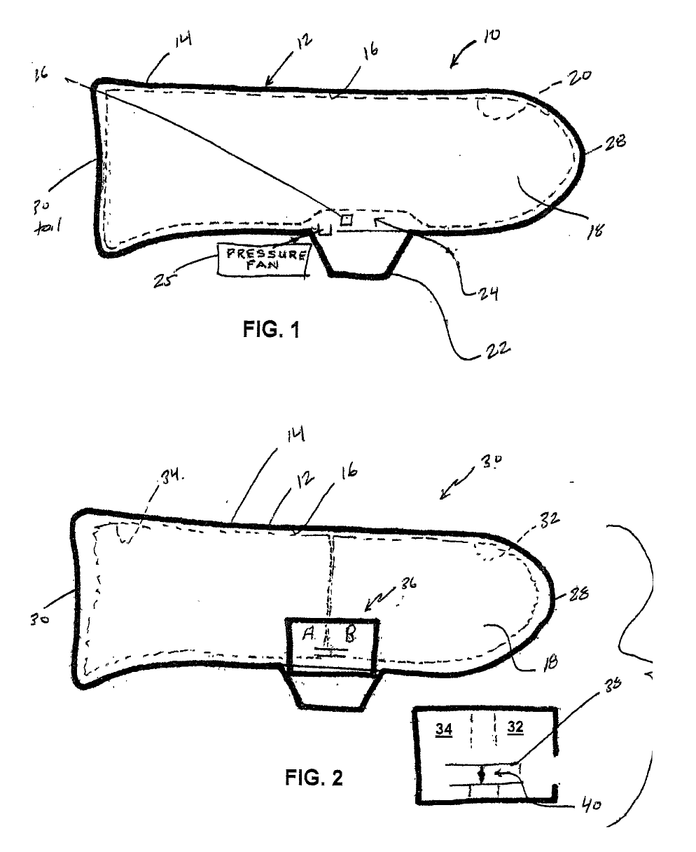

FIG. 2 depicts a second embodiment of the invention in which an airship 30 is constructed as described above with reference to the previous embodiment, however there are two gas bags within the envelope 18 rather than one. Specifically, a first gas bag 32 is positioned forwardly within the envelope 18, while a second gas bag 34 is positioned in a rearward location. One particularly advantageous feature of this embodiment of the invention is the provision of a novel system for maintaining the trim of the airship 30 that includes structure for selectively transferring gas between the first gas bag 32 and the second gas bag 34. According to this aspect of the invention, the structure for selectively transferring gas includes a passage 38 communicating the first gas bag 32 with the second gas bag 34, an impeller 40 positioned within the passage 38, and a controller, which in the preferred embodiment includes the pilot interface 62 and the system controller 60, for controlling movement of the impeller 40. Alternatively, an automatic trim adjustment mechanism could be employed using gyroscopic feedback or other known techniques.

In this embodiment, it is preferred that each bag 32,34 should hold approximately one-half of the total volume of gas required. In larger airships, more than two gasbags could be utilized with the same results. When any trim is needed, the gas itself is shifted to the necessary bag the use of the impeller 40. Trim is therefore obtained positively and quickly as any lift added to one section of the airship 30 removes the same amount of lift from the other an amount, in effect doubling the response. In other words, adding lift to one end of the airship while the same time decreasing the lift in the opposite end gives a quick seesaw effect. The natural ballonet is still effective, as the pressure inside the outer skin remains constant and only the movement of helium necessary for trim is required. The air inside the natural ballonet automatically goes to its proper location by the changes in pressure within the gasbag. Therefore, the natural ballonet and the automatic gas trim work both naturally and together, getting positive results.

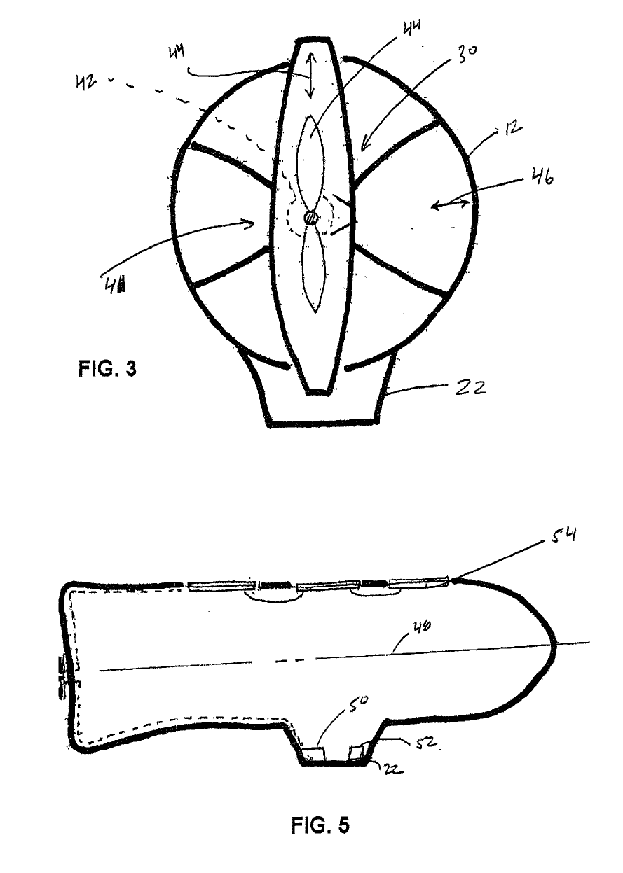

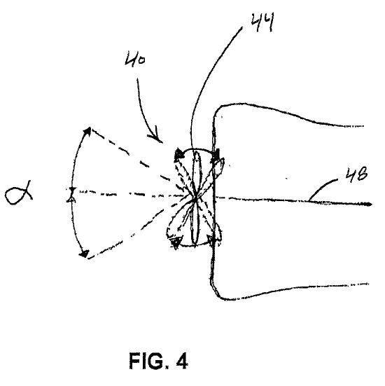

Referring now to FIG. 3 and 4, another advantageous feature of the invention that is preferably included in both of the above described embodiments is a propulsion mechanism 41 that is positioned proximate to the tail portion 30 of the airship. By being so positioned, the propulsion mechanism 41 is constructed and arranged to create propulsive thrust that may be vectored so as to be substantially colinear with a centerline 48 of the airship that extends through the nose portion 28 and the tail portion 30 of the airship. Centerline 48 further preferably extends through the center of mass of the airship as well. As is shown schematically in FIG. 3 and in FIG. 4, the propulsion mechanism 41 is adjustable both vertically and horizontally from a neutral position in which the propulsive thrust is so vectored to be substantially colinear with the centerline 48 to a multiplicity of alternative positions wherein the propulsive thrust is vectored to deviate from the direction of the centerline 48 in order to maneuver the airship. Referring briefly to FIG. 6, it will be seen that horizontal adjustment of the propulsion mechanism 41 is effected by means of a horizontal thrust adjustment mechanism 66 and, similarly, vertical adjustment c,f the propulsion mechanism 41 is effected by a vertical thrust adjustment mechanism 68. Both of the thrust adjustment mechanisms 66, 68 are responsive to instructions by the system controller 60 in response to input that is received from the pilot interface 62. The propulsion mechanism 41 and the vertically and horizontal thrust adjustment mechanisms 68,66 could be constructed in any one of the number of different ways, but it is preferred that the propulsion mechanism 41 includes a single propeller 44 that is powered by a lightweight electric motor 42. The lightweight electric motor 42 and propeller 44 are preferably mounted on gimbals so as to be pivotable through a predetermined range of movement both vertically and horizontally. In this preferred configuration, the horizontal and vertical thrust adjustment mechanisms 66, 68 may be linear actuators that will fit the motor and propeller to a desired location within the respective axis of movement. Alternatively, vertically and horizontal adjustment of the gimbal-mounted motor and propeller assembly could be effected manually by wires that are controlled by a manual flight stick or similar mechanism within the cockpit area.

Alternatively, the propulsion mechanism could be configured so that the motor and propeller are stationary and thrust is adjustable both horizontally and vertically by the use of adjustable vanes that are positioned aft of the propeller.

The center line thrust that is provided by this arrangement is most beneficial. As mentioned above, trim becomes necessary with speed. In the traditional airship the propulsion system is located at or near the bottom of the airship. At speed, the airship has a tendency to go nose up. But with the propeller located in the center rear of the envelope, there is no such problem. It simply operates much like an arrow propelled from a bow. The center of the weight of the airship is in direct line thrust, therefore there is little loss of energy. Historically, one of the major problems of the airship has been its steering mechanism. At the rear of the airship where usually the lift is least because of the shape, there are fans, elevators and rudders, and all the necessary weight involved in their construction and operation. Fins can be torn loose from the envelope by ground strikes on liftoff or landing, causing critically and expensive damage. Most important, however, is that there is really no steering capability until the airship has built up enough air speed to make the elevators and rudders do their jobs. Unfortunately, this speed is not available at the most critically and needed times, which are liftoff and landing, when the air speeds are necessarily slow.

However, a fully vectored steering system of the type that is described above will take care of these problems, especially if it is combined with the center line thrust as is also described above. Instant steering capability can be obtained if the propeller can be turned in any direction quickly and easily, especially if it is located in the center rear of the airship. A boat with an outboard motor can turn a full circle virtually within its own length, but only left or right. The same capability lies in the vectored thrust, but is not limited to horizontal changes. In addition it can be utilized to make turns or changes of course vertically or in a full circle. By using two linear actuators to rotate the motor/propeller around an axis, 360 degrees of direction of thrust is obtained. This gives instant directional control of the airship even at zero air speed. State-of-the-art, fly by wire is very reliable today. With vectored thrust, there are no controls or cables or pulleys to jam or break. No fans, elevators or rudders are necessary with the vectored thrust. This does away with many problems which have plagued airships from their very beginning. It also does away with a lot of weight, which is a concern in any aircraft. A vertically or horizontally pinched tail configuration will induce enough drag that much like feathers on an arrow, nothing else is necessary in the way of fans or the like. This is an advantage that has never been available before.

Another advantage of using an electric motor 42 as opposed to the conventional internal combustion engine is that the power source, which in this case is a source of electricity such as a battery 50, may be positioned remotely from the propulsion mechanism 41 that it location where the weight of the battery 50 will not adversely affect the performance of the airship. As is shown in FIG. 5, the battery 50 is preferably positioned in the area of the gondola 22. With the advances in batteries, solar panels, and the new fuel cells, the reliability of the electric motor is well within the acceptable range for use as a primary power source. In addition to being economical to operate, with electric power there is no pollution or noise, and with no hot exhausts, fire hazards are illuminated as there is no gasoline or oil. Electric motors are extremely reliable and present no starting problems on cold mornings. There are no problems with spark plugs, filters, points or ignition, and they require basically no maintenance. The technology makes lightweight electric motors possible with a ratio of as little as 125 pounds per horsepower, and an efficiency rate of higher than 90 percent. With no vibration from the power plant to be induced into the framework, this makes an electrically powered airship very desirable for certain applications. Either an AC or DC electric motor could be used.

Remote power supply is also an advantage of an electric powered airship. Traditionally, the internal combustion engine has inherent problems with remote fuel supply. There is the need to get the fuel to the engine and there is always the possible danger of fire. The use of batteries, solar panels or fuel cells give the freedom and safety of locating the power source in any desired site in the airship. They could be located in the nose of the ship if desired or in the car or placed in any advantageous location. The large surface of the airship also affords a perfect place for solar panels. But the major advantage of electric motors is that remote placement of power sources do not present the problems inherent in the fueling of the internal combustion engine. Electricity is easy to convey to be needed point.

Airships are noted for long duration aloft, as unlike heavier than aircraft they do not use energy to stay in the air, only for propulsion. However, batteries need to be recharged and in an electric airship this would be the limiting factor of time aloft. Therefore, as is shown schematically in FIG. 5, a recharging module 52 is provided that is preferably embodied as a generating power system using an internal combustion engine and an AC/DC generator fueled with propane. Alternatively, a fuel cell using the same fuel could be used for days of running on high power output, when needed for speed or handling in windy conditions or as a backup system. Even small airships would have high hours aloft capabilities with speed. In the embodiment shown in FIG. 5, one or more panels 54 of solar cells could also be used to recharge the battery 50.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

What is claimed is:

1. An airship, comprising:
an outer skin having an outer surface and an inner surface, said inner surface defining an envelope;
at least one gas bag contained within said envelope;
a cabin;
a pressure sensor positioned to sense air pressure at a location between said gas bag and said inner surface of said outer skin; and
pressurizing means for introducing outside air to said location when said pressure sensor detects that pressure at said location has reached a predetermined minimum pressure, whereby the envelope is sufficiently pressurized to maintain its outer shape without use of a ballonet.

2. An airship according to claim 1, wherein said location is positioned at a lower end of said envelope.

3. An airship according to claim 1,wherein said pressurizing means comprises a fan for directing outside air into a space within said envelope that is beneath said gas bag.

4. An airship according to claim 3, wherein said fan is an electric fan.

5. An airship according to claim 1,wherein said at least one gas bag comprises a first gas bag and a second gas bag.

6. An airship according to claim 5,further comprising means for selectively transferring gas between said first gas bag and said second gas bag to adjust the trim of the airship.

7. An airship according to claim 6,wherein said means for selectively transferring gas comprises a passage communicating said first gas bag with said second gas bag, an impeller positioned within said passage, and a controller for controlling movement of said impeller.

8. An airship according to claim 7,wherein said first gas bag is located in a position within said envelope that is forward of said second gas bag.

9. An airship according to claim 7,wherein said controller comprises an operator control for adjusting the trim of the airship.

10. An airship according to claim 1,wherein said outer skin defines a shape of said airship including a nose portion and a tail portion, and wherein said airship further comprises a propulsion mechanism that is positioned proximate to said tail portion.

11. An airship according to claim 10, wherein said propulsion mechanism is constructed and arranged to create propulsive thrust that is vectored so as to be substantially colinear with a centerline of said airship that extends through said nose portion and said tail portion of said airship.

12. An airship according to claim 11, wherein said propulsion mechanism is adjustable between a neutral position wherein said propulsive thrust is vectored so as to be substantially colinear with said centerline and a multiplicity of alternative positions wherein said propulsive thrust is vectored to deviate from the direction of said centerline to maneuver the airship.

13. An airship according to claim 12, wherein said propulsion mechanism is horizontally adjustable.

14. An airship according to claim 13, wherein said propulsion mechanism is further vertically adjustable.

15. An airship according to claim 12, wherein said propulsion mechanism is vertically adjustable.

16. An airship according to claim 10, wherein said propulsion mechanism comprises a propeller and an electric motor.

17. An airship according to claim 16, further comprising a power source for providing electricity to said electric motor, and wherein said power source is positioned remotely from said electric motor.

18. An airship, comprising:
an outer skin having an outer surface and an inner surface, said outer surface defining a nose portion and a tail portion of said airship and said inner surface defining an envelope;
at least one gas bag contained within said envelope;
a cabin; and
a propulsion mechanism that is positioned proximate to said tail portion, said propulsion mechanism being constructed and arranged to create propulsive thrust that is vectored so as to be substantially colinear with a centerline of said airship that extends through said nose portion and said tail portion of said airship.

19. An airship according to claim 18, wherein said propulsion mechanism is adjustable between a neutral position wherein said propulsive thrust is vectored so as to be substantially colinear with said centerline and a multiplicity of alternative positions wherein said propulsive thrust is vectored to deviate from the direction of said centerline to maneuver the airship.

20. An airship according to claim 19, wherein said propulsion mechanism is horizontally adjustable.

21. An airship according to claim 20, wherein said propulsion mechanism is further vertically adjustable.

22. An airship according to claim 19, wherein said propulsion mechanism is vertically adjustable.

23. An airship according to claim 18, wherein said propulsion mechanism comprises a propeller and an electric motor.

24. An airship according to claim 23, further comprising a power source for providing electricity to said electric motor, and wherein said power source is positioned remotely from said electric motor.
